(19) United States
(12) Patent Application Publication
(10) Pub. No.: US 2003/0171635 A1
(43) Pub. Date: Sep. 11, 2003

(54) Method for treatment of hazardous fluid organic waste materials

(76) Inventors: Tamas Bereczky, Godolloi (HU); Gyory Tibor, Bp Bankut (HU); Heredy Laszlo, Irvine, CA (US); Herpay Andras, Bp Tutaj (HU); Pocsy Ferenc, Bp Versec (HU)

Correspondence Address: David J Heller, Ridout & Maybee, Suite 2400, One Queen Street East, Toronto, ON, M5C 3B1, CA

(21) Appl. No.: 10/258,729

(22) PCT Filed: Feb. 26, 2001
(86) PCT No.: PCT/HU01/00022

(51) Int. Cl. A62D 3/00

(52) U.S. Cl. 588/212

(57) ABSTRACT

Method for treatment of fluid hazardous, organic waste materials, where a plasma of 2000-5000° C. temperature is generated by means of an electric arc in a plasma generator, the plasma torch is directed into a reactor, the reactor consists of three zones (4A, 4B, 4C), the plasma torch being introduced downwards into the uppermost first zone (4A), the fluid waste (1) being sprayed into the plasma torch in the first zone (4A), where it is heated to a temperature range of 1300-1600° C., the mixture of the plasma and the waste is introduced into the second zone (4B) of the reactor, where an oxidizing material is added (5) to the mixture, the combustion gas produced in the second zone (4B) is then led into the third zone (4C) of the reactor, where it is cooled rapidly by water spraying to a temperature range of 120-160° C., the cooled combustion gas is removed from the third zone (4C) of the reactor is led into a cooler. The plasma torch is generated from the mixture of carbon dioxide and oxygen, the oxidizing material introduced into the second zone (4B) of the reactor is a mixture of carbon dioxide and oxygen. Subsequently the water content of the combustion gas is separated by condensing and is removed and the residual combustion gas is removed.

### TECHNICAL FIELD

The object of this invention is a method for treatment of fluid hazardous, organic waste materials, where a plasma of 2000-5000° C. temperature is generated by means of an electric arc in a plasma generator, the plasma torch is directed into a reactor, the reactor consists of three zones, the plasma torch being introduced downwards into the uppermost first zone, the fluid waste being sprayed into the plasma torch in the first zone, where it is heated to a temperature range of 1300-1600° C., the mixture of the plasma and the waste is introduced into the second zone of the reactor, where an oxidizing material is added to the mixture, the combustion gas produced in the second zone is then led into the third zone of the reactor, where it is cooled by rapid cooling to a temperature range of 120-160° C., the cooled combustion gas is removed from the third zone of the reactor is led into a cooler, where it is cooled to a temperature range of 25-40° C.

### BACKGROUND ART

In the past, in the industry for the treatment of organic waste materials the incineration was the accepted method, which takes place in a temperature range of 1250-1450° C. with excess of oxygen. In case of highly chlorinated organic wastes this temperature range can be attained by conventional combustion only by the use of oil fired supporting burners and with the enrichment of the necessary air with oxygen. Due to the high temperatures and the excess oxygen, nitrogen oxides are formed during the combustion. The subsequent elimination of nitrogen oxides from the combustion gases needs costly apparatus and continuous expenditures.

The parameters of combustion gases according to the actually effective environment protection regulations can be fulfilled only by a few of the conventional refuse burner, therefore the developments tend in the direction of plasma technology methods, assuring a still higher combustion temperature.

According to the HU 184 389 patent, technical plasma is produced from the waste, which, by introduction of excess oxygen is transformed into a stable combustion product. The oxygen is introduced into the system along with the air. The disadvantage of this method is, that the plasma produced from halogenated organic materials is highly corrosive, so the lifetime of the electrodes of the plasma generator is reduced. Using air as energy transmitting medium, due to the high nitrogen content a considerable quantity of nitrogen oxide is generated. As an oxygen excess is to be maintained within the reactor, the produced nitrogen oxides can be removed from the combustion gas only by means of a costly treatment.

According to the U.S. Pat. No. 4,582,004, the energy is introduced into the system by an air supplied plasma generator, in which the oxygen is maintained in the generator much below the stoichiometric level. In such circumstances carbon monoxide and hydrogen are formed, which reduce the nitrogen oxides. After a neutralizing washing of the combustion gas, it is burned in an excess gas burner in free space. The disadvantage of this method is that in the washing liquid elementary carbon arises (soot), which is considered as hazardous waste and it is to be removed by filtration.

Furthermore, the present environmental standards do not allow the burning of the hazardous waste gases by excess gas burners.

A third method is known as the PLASCON method (11th Int. Symp. on Plasma Chem., 1993, Longborough, p. 686-691). With this method argon gas is utilized as energy transmitting medium. The waste is sprayed into the plasma using hydrogen or oxygen as carrier gas. The oxygen necessary for the combustion is supplied into the reactor below the stoichiometric level. After rapid cooling of the formed hydrogen-carbon monoxide mixture, it is burned in an excess gas burner. This system does not contain any energy recuperating means. The use of argon as plasma gas eliminates the formation of nitrogen oxides, but makes this method uneconomical.

The above mentioned methods have the following disadvantages:

1. In case of energy introduction by air supplied plasma, if the oxygen quantity introduced into the reactor exceeds the stoichiometric level by 5 . . . 6%, the nitrogen oxide will exceed the allowable level, whilst if the introduced oxygen quantity is reduced, the level of the carbon monoxide and of the hydrocarbons not combusted increases, what leads to the deterioration of the efficiency of the treatment, and formation of dioxins and furanes, respectively.

2. If the level of oxygen in the reactor is held deeply under the stoichiometric level, during the cooling of combustion gases soot is formed, which is to be removed continuously.

3. If argon is used for energy transfer medium, its high cost will further increase the otherwise also high costs.

### DISCLOSURE OF INVENTION

It is an object of the present invention to provide a method for the treatment of hazardous organic fluid waste materials, with which the advantages of the high temperature plasma can be maintained, namely the rapid atomization of the waste, the compact equipment design, the high decomposition efficiency, at the same time the full utilization of the combustion products, to avoid the emission of any gaseous or fluid hazardous materials, inclusive the formation of nitrogen oxides as well. The aim is furthermore to produce from the waste useful products.

The invention is based on the recognition, that

The formation of nitrogen oxides can be avoided by using instead of air carbon dioxide or carbon dioxide enriched with oxygen as plasma forming medium and using oxygen or carbon dioxide enriched with oxygen in the reactor for the oxidization of the atoms formed during the decomposition of the fluid waste. After having removed the formed acids (hydrochloric acid, hydrogen fluoride, sulfuric acid, phosphorus acid) from the combustion gases the remaining water vapors can be condensed by cooling and the dry gas contains only carbon dioxide and the excess oxygen, which can be recycled into the reactor, and

by compressing and cooling the dry gas the carbon dioxide can be selectively liquefied, so a well separated useful product is formed, because the oxygen with the equivalent amount of carbon dioxide remains in gas phase,

a part of the carbon dioxide or the carbon dioxide and oxygen gas mixture can be recycled into the plasma generator, so in a continuous operation an emission of gaseous materials can be excluded and the equipment needs to be supplied with the amount of oxygen necessary for the stoichiometric combustion,

the water contained in the combustion gas and condensed by means of a cooler can be utilized in the reactor for the rapid cooling of gases,

if the thermal energy produced in the system is utilized for the evaporation of the exhausted washing alkali, the salt can be crystallized from the evaporated liquid and the remaining alkali poor in salt can be recycled into the system.

Based on the above disclosed recognition, the aims were achieved by the method according to this invention, where the plasma torch is generated from the mixture of carbon dioxide and oxygen, the oxidizing material introduced into the second zone of the reactor is a mixture of carbon dioxide and oxygen, furthermore the rapid cooling is carried out by means of water spraying, then the combustion gas is fed together with the water vapor into a condenser, used as cooler, where the water content of the combustion gas is separated by condensing and is removed and the residual combustion gas is removed.

So the plasma has been generated from the carbon dioxide-oxygen gas mixture, obtained from the continuous technology as end product, that is the oxidation is performed in the reactor with the introduced oxygen and not with air, the combustion gases do not contain nitrogen, thus in the reactor no nitrogen oxides are formed.

Due to the fact, that the plasma is generated from carbon dioxide and oxygen, and a mixture of carbon dioxide and oxygen is introduced into the second zone of the reactor, it can be assured, that the combustion gases shall not contain nitrogen oxide.

In case waste materials having combustion heat of 12000-45000 kJ/kg are treated, the temperature of the second zone of the reactor is controlled to a temperature range of 1300 to 1600° C. by varying the ratio of the carbon dioxide and oxygen introduced into the second zone of the reactor.

According to a preferred embodiment of the method according to the present invention, before introducing into the condenser the cooled combustion gas removed from the third zone of the reactor is passed through a gas washing unit, where the combustion gas is contacted with an alkaline washing liquid, during which the combustion gas is cooled to a temperature range of 80-95° C.

The use of the washing unit is especially necessary when halogenated hazardous waste materials are processed, in this unit the halogenated compounds of the combustion gas are neutralized by an alkali.

Using the firth embodiment of the method according to the invention, when processing fluid waste material having high carbon content, water is added to the mixture of oxygen and carbon dioxide sprayed into the second zone of the reactor.

The water removed from the condenser is preferably recycled into the second zone of the reactor for rapid cooling. Thus the water consumption and its cost can be saved.

The carbon dioxide content of the removed combustion gas is preferably liquefied and utilized. Thus a significant part of the combustion gas can be exploited.

The combustion gas is utilized partly by directing the carbon dioxide and oxygen from the dry gas into the plasma generator and into the second zone of the reactor.

The oxygen for oxidation of the fluid waste material is fed in excess quantity into the second zone of the reactor. Thus, the production of stable oxides in the combustion gas can be assured. Of course, when treating wastes containing nitrogen, the formation of nitrogen-oxides occurs in a small quantity only, which is much below the admissible level.

By implementing the method according to present invention, if the waste does not contain nitrogen, than there is no liquid, nor gaseous emission from the equipment.

If the waste material contains nitrogen, then besides the formed small amount of nitrogen oxide, the residual nitrogen together with the excess amount of oxygen remain in gaseous phase, which will be removed.

### BRIEF DESCRIPTION OF DRAWINGS

The invention will be discussed in details based on the following drawing, where

FIG. 1 is the simplified schematic diagram of an equipment implemented according to present invention.

### BEST MODE FOR CARRYING OUT THE INVENTION

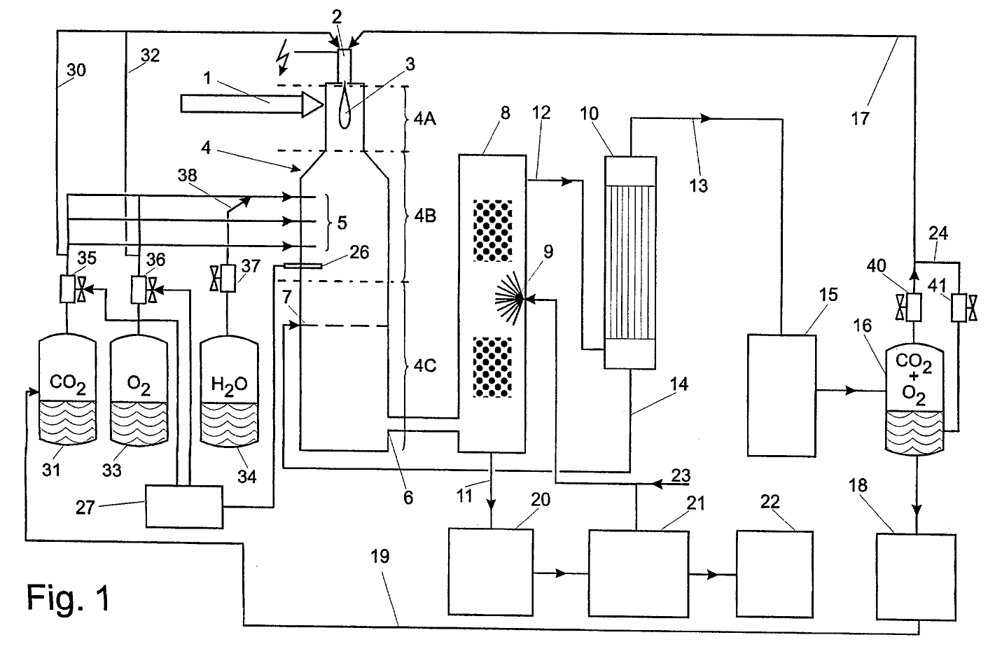

In the equipment shown on FIG. 1 a plasma generator 2 is provided in an electric plasma generator known per se, which has an electric input and a gas inlet. The gas inlet is connected through a pipeline 30 and valve 35 to a carbon dioxide storage vessel 31 and through a valve 36 to a oxygen storage vessel 33. The plasma generator 2 is directed into the top of a first zone 4A of a reactor 4, which is essentially vertical, cylindrical and heat-insulated. Into the first zone 4A leads from one side the fluid waste inlet nozzle 1, which vaporizes the fluid waste fed into the plasma torch 3.

On the second zone 4B of the reactor 4, below the first zone 4A, there are inlet devices 5 supplying carbon dioxide from the storage vessel 31 and oxygen from the oxygen storage vessel 33 and water can be supplied from the water storage vessel 34 through a valve 37 and a pipeline 38 to at least one of the inlet devices 5.

On the second zone 4B, preferably below the inlet devices 5, a temperature sensor 26 is placed, the output of which is electrically connected to a control circuit 27. The control circuit 27 has two outputs, one of which is connected to a control input of a valve 35, connected to the carbon dioxide storage vessel 31, the second output is connected to the control input of a valve 36, being on the oxygen storage vessel 33. The control circuit 27 is an electric circuit, but alternatively the control circuit can be built up of pneumatic elements as well.

The lowest part of the reactor 4 is the third zone 4C, on the side wall of which water spraying armatures 7 are fitted. In the third zone 4C, below the water spraying armatures 7 a combustion gas outlet 6 is provided.

To the combustion gas outlet 6 either directly or optionally through a gas washing unit 8 a condenser 10 is connected for cooling and separation the water content of the combustion gas.

The bottom part of the gas washing unit 8 is formed as a storage vessel containing alkali necessary for washing and neutralizing the combustion gases. In the side wall of the upper part of the gas washing unit 8 alkali spraying armatures 9 are mounted. The exhausted washing alkali is let off from the lower part of the 8 washing unit via pipeline 11. The washed combustion gas is bypassed through a 12 pipeline to the condenser 10.

The water content of the combustion gases washed in the 8 washing unit will be deposited in the condenser 10. The dry gases are drained through the pipeline 13 from the condenser 10 and preferably recycled to the water spraying armatures 7 of the third zone 4C of the reactor 4.

The dried combustion gas delivered through the pipeline 13 is carried to a liquefaction equipment 15, where the carbon dioxide component of the combustion gas is fluidized. The liquefied carbon dioxide gas is stored in a liquefied gas storage vessel 16. The other gases, as oxygen and a small amount of other gases in the combustion gas are in the liquefied gas storage vessel 16 in gas condition.

In the embodiment shown in FIG. 1 the following processes takes place:

In the 2 plasma generator, using the oxygen-carbon dioxide mixture, fed from the carbon dioxide vessel 31 and oxygen storage vessel 33, a high temperature (2000 . . . 5000° C.) ionized gas torch is generated, into which the waste or the mixture of waste and water is fed. By heat exchange the waste material is heated to a temperature range of 1300 . . . 1600° C. and will be atomized.

In the presence of oxygen an incineration process starts in the plasma torch 3, the reaction heat of which contributes to maintaining the combustion. Due to the presence of oxygen coming through the inlet devices 5 into the second zone 4B of the reactor 4 the oxidation continues. In order to limit the temperature, depending on the heat content of the waste material, carbon dioxide and/or water is fed into the second zone 4B of the reactor 4 through the inlet devices 5. The combustion gases dwell in the third zone 4C of the reactor 4, where they are cooled by rapid cooling with water sprayed through the water spraying armatures 7 to a temperature of 120 . . . 160° C.

In cases when wastes with high, preferably 12000 . . . 45000 kJ/kg combustion heat are processed, the temperature in the second zone 4B of the reactor 4 may be controlled by varying the proportion of the oxygen and carbon dioxide. In case of too high temperatures the temperature sensor 26 operates the control circuit 27 in such a manner, that one of its outputs opens the 35 valve and increases the amount of carbon dioxide feeding, while the other output controls the valve 36 to close and diminishes the fed amount of oxygen. If the temperature of the second zone 4B decreases, the oxygen feed has to be increased and the carbon dioxide feed decreased.

The cooled combustion gases are conducted optionally into a gas washing unit 8, where large surface ceramic bodies make the alkaline washing liquid contacted with the combustion gases, simultaneously the temperature of the gases decreases to a temperature range of 80 . . . 95° C. The alkaline washing liquid neutralizes the acid content of the combustion gases.

The great part of the water content of the combustion gases is eliminated by water cooling in the 10 condenser. The condensed water in the 10 condenser is recycled to the rapid cooler in the third zone 4C of the reactor 4, through the water spraying armatures 7.

The exhausted hot alkali flows through the 11 pipeline in a 20 alkali evaporation equipment, where it is evaporated in a low pressure space. The thickened hot alkali flows into the 21 salt crystallizing unit, where the salt content is crystallized and forwarded into a 22 storage vessel. The alkali with reduced salt content is recycled through a 25 pipeline into the 8 gas washing unit, meanwhile the lost alkali will be compensated through a pipeline 23 to increase its concentration to the wanted level.

The process is shown by an example showing treatment of organic waste with chlorine content. Of course, the method is suitable for the treatment of other hazardous organic chemicals (fluorine, sulfur, phosphor, etc.) also.

### EXAMPLE 1

Treatment of tetrachloro-benzene (C₆H₂Cl₄)

The waste is preferably mixed with a cheap hydrocarbon or organic material having high hydrogen content to get a H/Cl atomic ratio exceeding 2.0, to assist achieving the formation of hydrogen-chloride. In reactor 4 the following processes take place:

C₆H₂Cl₄+2CH₃OH+8.5O₂=8CO₂+4HCl+3H₂O

216 kg 64 kg 272 kg 352 kg 146 kg 54 kg

The washing of combustion gases is performed with sodium carbonate (Na₂CO₃).

4HCl+2Na₂CO₃=4NaCl+2CO₂+2H₂O

146 kg 212 kg 234 kg 88 kg 36 kg

Thus, with the treatment of 1 kg of tetrachloro-benzene 2.04 kg of carbon dioxide and 1.08 kg of sodium chloride are produced, which can be utilized. 1.26 kg of oxygen, 0.3 kg of methanol and 0.98 kg of sodium carbonate were used.

### EXAMPLE 2

Treatment of trichloro-biphenyl (C₁₂H₇Cl₃)

C₁₂H₇Cl₃+13O₂=12CO₂+3HCl+2H₂O

257.5 kg 416 kg 528 kg 109.5 kg 36 kg

3HCl+1.5Na₂CO₃=3NaCl+1.5CO₂+1.5H₂O

109.5 kg 159 kg 175.5 kg 66 kg 27 kg

Thus when treating 1 kg of trichloro-biphenyl 2.30 kg of carbon dioxide and 0.68 kg of sodium chloride are obtained. 1.62 kg of oxygen and 0.62 kg of sodium carbonate are used.

The method according to the invention has the following advantages.

By means of the method according to the invention from the hydrocarbon waste materials pure, utilizable carbon dioxide can be produced and this reduces considerably the deterioration costs.

When treating waste materials without nitrogen content the nitrogen oxide emission can be completely avoided, processing wastes with low nitrogen content, it can be held on a low level, (when compared to the incineration with air), as the nitrogen is present in the reactor in a low concentration.

The sodium chloride formed during the neutralization of combustion gases leaves the equipment in solid state and it may be utilized commercially.

No hazardous byproducts are formed from the hazardous waste material.

The process is water saving.

1. Method for treatment of hazardous fluid organic waste material, where a plasma torch (3) of 2000-5000° C. temperature is generated by means of an electric arc in a plasma generator (2), the plasma torch (3) is directed into a reactor (4),
the reactor (4) consists of three zones (4A, 4B, 4C), the plasma torch (3) being introduced downwards into the uppermost first zone (4A) of the reactor (4),
the fluid waste being sprayed into the plasma torch (3) in the first zone (4A) of the reactor (4) where it is heated to a temperature range of 1300-1600° C.,
the mixture of the plasma (3) and waste is introduced into the second zone (4B) of the reactor (4), where an oxidizing material is added to the mixture,
the combustion gas produced in the second zone (4B) of the reactor (4) is led into the third zone (4C) of the reactor (4), where it is cooled by rapid cooling to a temperature range of 120-160° C.,
the cooled combustion gas is removed from the third zone (4C) of the reactor (4) and
is led into a cooler, where the combustion gas is cooled to a temperature range of 25-40° C.,
characterized in, that
the plasma torch (3) is generated from the mixture of carbon dioxide and oxygen,
the oxidizing material introduced into the second zone (4B) of the reactor (4) is a mixture of carbon dioxide and oxygen is,
the rapid cooling is carried out by means of water spraying, then
the combustion gas is fed together with the water vapor into a condenser (10) utilized as cooler, where the water content of the combustion gas is separated by condensing and is removed and
the residual combustion gas is removed.

2. The method according to claim 1, characterized in that, in case the waste materials having combustion heat of 12000-45000 kJ/kg are treated, the temperature in the second zone (4B) of the reactor (4) is controlled to a temperature range of 1300 to 1600° C. by varying the ratio of the carbon dioxide and oxygen introduced into the second zone (4B) of the reactor (4).

3. The method according to claim 1, characterized in that before introducing into the condenser (10) the cooled combustion gas removed from the third zone (4C) of the reactor (4) is passed through a gas washing unit (8), where the combustion gas is contacted with an alkaline washing liquid, during which the combustion gas is cooled to a temperature range of 80-95° C.

4. The method according to claim 1, characterized in that in case of processing fluid waste having high carbon content, water is added to the mixture of oxygen and carbon dioxide sprayed into the second zone (4B) of the reactor (4).

5. The method according to claim 1, characterized in that the water removed from the condenser (10) is recycled into the third zone (4C) of the reactor (4) for rapid cooling.

6. The method according to claim 1, characterized in that the carbon dioxide content of the removed combustion gas is liquefied and utilized.

7. The method according to claim 1, characterized in that the carbon dioxide and oxygen originating from the dried combustion gas is recycled into the plasma generator (2), and into the second zone (4B) of the reactor (4).

8. The method according to claim 1, characterized in that the oxygen is fed in excess quantity compared to the stoichiometric level for the oxidation of the fluid waste material.
